(19) United States
(12) Patent Application Publication
(10) Pub. No.: US 2018/0252540 A1
(43) Pub. Date: Sep. 6, 2018

(54) METHOD AND SYSTEM FOR PROVIDING ROUTE GUIDANCE USING NAVIGATION SYSTEM

(71) Applicant: NHN Entertainment Corporation, Seongnam-si (KR)

(72) Inventor: Chuljae Lim, Seongnam-si (KR)

(21) Appl. No.: 15/907,139

(22) Filed: Feb. 27, 2018

(30) Foreign Application Priority Data
Mar. 3, 2017 (KR) 10-2017-0027752

(51) Int. Cl. G01C 21/34; G01C 21/36; G06Q 30/02

(52) U.S. Cl. CPC G01C 21/343; G01C 21/3415; G06Q 30/0207; G01C 21/3484; G01C 21/362; G01C 21/3492

(57) ABSTRACT

A method and system for providing service using a navigation system are disclosed. A method of providing route guidance performed by a navigation server may include receiving input time information for a source and a destination from a device when the source and the destination are inputted on a device, searching for a section connecting the source and the destination based on the input time information, determining whether a route for the section is present, wherein the route is generated by connecting nodes within the section, providing the device with a list of at least one route within the section if the route for the section is present, and notifying a ranking and game server so that the ranking and game server offers a reward to the device based on driving result information obtained.

### CROSS REFERENCE TO RELATED APPLICATION

The application claims priority from and the benefit of Korean Patent Application No. 10-2017-0027752, filed on Mar. 3, 2017, which is hereby incorporated by reference for all purposes as if fully set forth herein.

### BACKGROUND

### Field

Exemplary embodiments of the invention relate generally to an information providing technology and, more specifically, to a method and sever for providing route guidance Using a Navigation System.

### DISCUSSION OF THE BACKGROUND

In general, a navigation system on which a global positioning system (GPS) for confirming a corresponding current location and moving speed or determining a moving route has been mounted is used in a ship, an aircraft, a vehicle, and a mobile terminal. The navigation system has a route search and guidance function for detecting the current location of a moving body, matching the current location of the moving body with map data, searching the map data for a driving route from the matched current location of the moving body to a destination, and providing guidance so that the moving body can safely travel to the destination along the driving route using GPS messages received from a plurality of GPS satellites belonging to the GPS and signals detected by a plurality of sensors, including a gyro sensor disposed in the moving body to detect a driving direction and a speed sensor to detect a driving speed.

In performing the route search function, a route is searched for by taking into consideration predetermined conditions, for example, expressway priority, traffic congestion area avoidance, a free road, and the shortest distance with respect to roads located between the current location of a vehicle or a source input by a user and a destination.

However, a conventional technology provides the same route to users who use the same navigation system in a specific situation, such as a traffic jam or the generation of an accident, because a driving route is searched for based on conditions set by a navigation system manufacturer. Accordingly, there is a problem in that the time taken to reach a destination is long because users drive a route having a traffic jam, which is guided by the navigation system.

Reference document: Korean Patent Application Publication No. 10-2012-0086579

The above information disclosed in this Background section is only for understanding of the background of the inventive concepts, and, therefore, it may contain information that does not constitute prior art.

### SUMMARY

Exemplary embodiments provide a method of providing guidance of an optimal route based on driving information obtained by analyzing driving information for various routes within a section that connects a source and a destination based on input time information for the source and the destination.

Exemplary embodiments provide a method of obtaining a faster optimal route by integrating a game method into a specific section set in a route.

Exemplary embodiments provide a method of providing route guidance by a navigation server, which include the steps of receiving input time information for a source and a destination from a device when the source and the destination are inputted on the device, searching for a section connecting the source and the destination based on the input time information, determining whether a route for the section is present, wherein the route is generated by connecting a plurality of nodes within the section, providing the device with a list of at least one route within the section if the route for the section is present, and notifying a ranking and game server so that the ranking and game server offers a reward to the device based on driving result information obtained with respect to a specific section set as a vehicle travels on a route selected from the list.

Exemplary embodiments provide a navigation server for providing route guidance that includes a processor. The processor is configured receive input time information for a source and a destination from a device when the source and the destination are input, search for a section connecting the source and the destination based on the time information, determine whether a route for the section is present, wherein the route is generated by connecting a plurality of nodes within the section, provide the device with a list of at least one route within the section if the route for the section is present, and notify a ranking and game server so that the ranking and game server offers a reward to the device based on driving result information obtained with respect to a specific section set as a vehicle travels on a route selected from the list.

Exemplary embodiments provide an information provision system, which may include a collection server configured to collect driving information generated when a vehicle travels on a route for a section connecting a source and a destination based on the source, the destination, and input time information for the source and the destination, a big data storage server configured to store the driving information collected by the collection server, a big data analysis server configured to obtain driving result information by analyzing the driving information stored in the big data storage server, a ranking and game server configured to assign ranking to a route on which the vehicle has traveled based on the driving result information, offer a reward according to the ranking, and set notification for a specific section between first and second nodes included in the route, and a navigation server configured to provide a list of at least one route within the section connecting the source and the destination in real time and to update an optimal route for the vehicle based on the driving result information.

Additional features of the inventive concepts will be set forth in the description which follows, and in part will be apparent from the description, or may be learned by practice of the inventive concepts.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a diagram for illustrating an operation of an information provision system according to an exemplary embodiment.

FIG. 2 is a block diagram showing an example of elements which may be included in the processor of a navigation server according to an exemplary embodiment.

FIG. 3 is a flowchart for illustrating a method of providing, by the navigation server, a route guidance service according to an exemplary embodiment.

FIG. 4 is a diagram illustrating an example in which the navigation server according to an exemplary embodiment provides a route guidance service.

FIG. 5 is a diagram illustrating that the navigation server according to an exemplary embodiment provides the route of a section that connects a source and a destination.

FIG. 6 is a diagram for illustrating that a new route not provided by the navigation server according to an exemplary embodiment is updated.

FIG. 7 is an example in which the navigation server according to an exemplary embodiment provides a user interface for querying whether driving information for a vehicle will be collected.

FIG. 8 is an example in which the navigation server according to an exemplary embodiment provides a list including routes for a section that connects a source and a destination.

FIG. 9 is an example in which when a vehicle according to an exemplary embodiment enters a specific section set by a ranking and game server, a device is notified of the entrance.

FIG. 10 is an example in which the ranking and game server according to an exemplary embodiment rewards the device.

FIG. 11 is a diagram illustrating that a big data storage server according to an exemplary embodiment stores driving information.

FIG. 12 is a diagram illustrating that the ranking and game server according to an exemplary embodiment assigns ranking and scores for each of pieces of information and stores them.

### DETAILED DESCRIPTION

In the following description, for the purposes of explanation, numerous specific details are set forth in order to provide a thorough understanding of various exemplary embodiments or implementations of implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

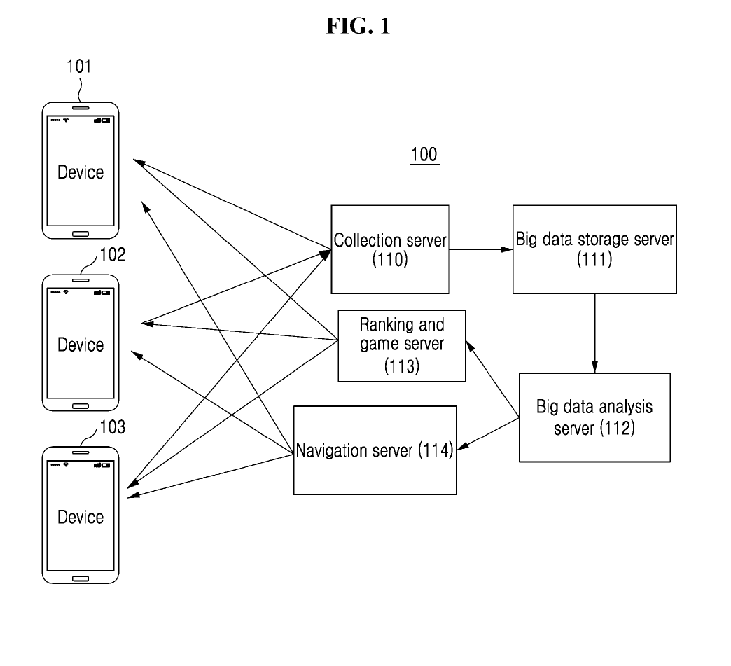

FIG. 1 is a diagram for illustrating an operation of an information provision system according to an exemplary embodiment.

A device 101 may be a fixed terminal or a mobile terminal implemented as a computer device. For example, the device 101 may include a smartphone, a mobile phone, the navigation system, a computer, a notebook, a terminal for digital broadcasting, personal digital assistants (PDA), a portable multimedia player (PMP), and a tablet PC. For example, the device 101 may be a navigation system disposed in a vehicle or a smart device providing a navigation system function. The device 101 may communicate with other terminals and/or servers 110, 111, 112, 113, and 114 over a network using a wireless or wired communication method.

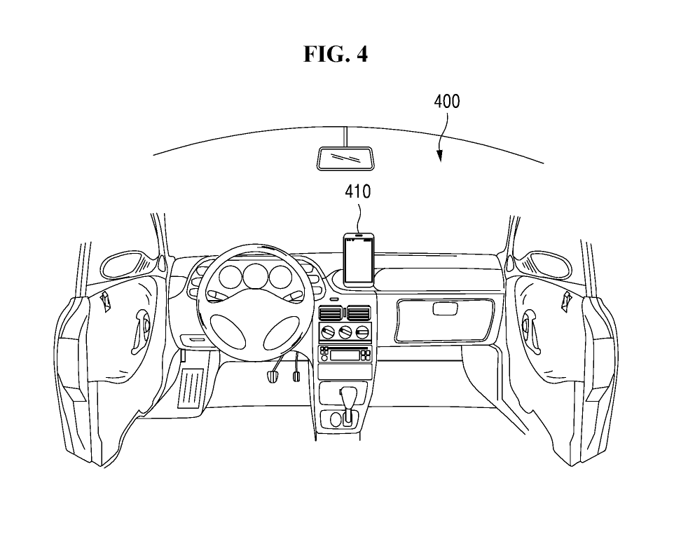

More specifically, FIG. 4 is a diagram illustrating an example in which a navigation server according to an embodiment provides a route guidance service. A route guidance service may be provided by the device 101 disposed in a vehicle 400. For example, the device 101 may be provided with a route guidance service that connects a source and a destination based on input time information for the source and the destination in a vehicle or moving means, such as a private car, a truck, a bus, or a bicycle. A navigation server 114 may search for a section that connects the source and the destination, and provide guidance of a route present in the section in a list form. A user may be provided with guidance of detailed information about a selected route from the list output by the device 101.

A communication method is not limited, and may include short-distance wireless communication between devices in addition to a communication method using a communication network (e.g., a mobile communication network, the wired Internet, the wireless Internet, and a broadcast network). For example, the network may include one or more networks, such as a personal area network (PAN), a local area network (LAN), a campus area network (CAN), a metropolitan area network (MAN), a wide area network (WAN), a broadband network (BBN), and the Internet. Furthermore, the network may include one or more network topologies, including a bus network, a star network, a ring network, a mesh network, a star-bus network, and a tree or hierarchical network, but is not limited thereto.

The information provision system may include a collection server 110, a big data storage server 111, a big data analysis server 112, a ranking and game server 113, and a navigation server 114. The servers 110, 111, 112, 113, and 114 may be implemented as a computer device that provides a command, code, a file, content, and service through communication with the device 101 over a network 120 or a plurality of the computer devices.

The collection server 110 may collect driving information generated as a vehicle travels on the route of a section that connects a source and a destination based on input time information for the source and the destination from the device 101. The collection server 110 may collect identification information of the device 101 and speed, direction, and location information (e.g., coordinates information) of a vehicle in which the device is disposed.

The big data storage server 111 may store driving information collected by the collection server 110. For example, the big data storage server 111 may store identification information of the device 101 and speed, direction, and location information (e.g., coordinates information) of a vehicle in which the device is disposed. For example, in the case of commute time, the big data storage server may store big data, such as traffic state information for each section, congestion avoidance data, and new real-time route guidance information. The information stored in the big data storage server may be used in a real-time navigation system service or may be applied to a self-service.

The big data analysis server 112 may obtain driving result information by analyzing driving information stored in the big data storage server 111. The big data analysis server 112 may transfer the driving result information to the ranking and game server 113 and the navigation server 114.

The big data analysis server 112 may analyze at least one of time taken for a vehicle to drive a route, speed at which the vehicle travels on the route, and information about each section (e.g., time information, speed information, whether acceleration or deceleration is applied, and speed limit for each section) included in the route. The big data analysis server 112 may analyze a new route generated as a vehicle travels a different route other than a route provided by the navigation server 114, or a new route generated as a vehicle travels a different route while the vehicle travels a route selected from a list.

The ranking and game server 113 may provide ranking for a route on which a vehicle has traveled and a reward according to the ranking based on driving result information, and may set notification for a specific section between first and second nodes included in the route. The ranking and game server 113 may convert a score assigned to a route on which a vehicle has traveled based on driving result information analyzed by the big data analysis server, and may assign ranking to the route on which the vehicle has traveled based on the converted score. The ranking and game server 113 may assign a greater reward to a device connected to a vehicle that travels on a route not preferred by other. In other words, the ranking and game server 113 may initiate ranking by assigning ranking to obtained information, and may produce a reward according to the ranking. The ranking and game server 113 may increase a score of a vehicle whose mileage is a predetermined reference or more, and may reduce a score of a vehicle having a violation matter.

The navigation server 114 may show a list of at least one route within a section that connects a source and a destination in real time, and may update an optimal route for a corresponding vehicle based on driving result information. If a route on which a vehicle has traveled is not included in a list, the navigation server 114 may update the list with the route on which the vehicle has traveled as a new route.

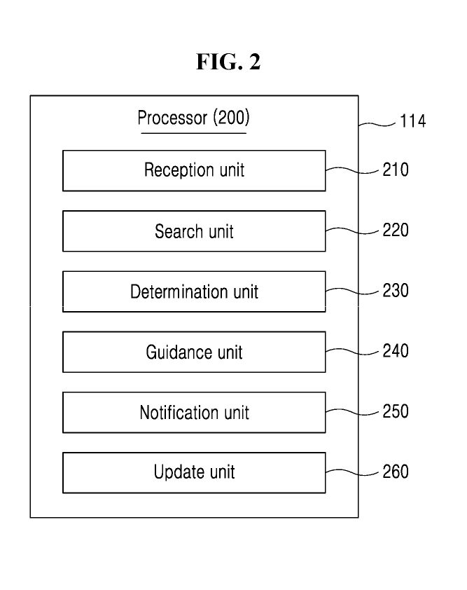

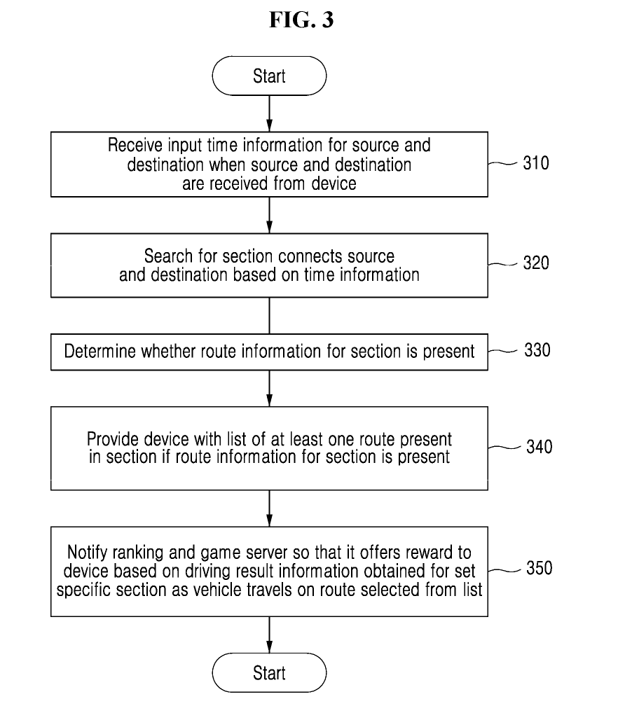

FIG. 2 is a block diagram showing an example of elements which may be included in the processor of the navigation server according to an exemplary embodiment. FIG. 3 is a flowchart for illustrating a method of providing, by the navigation server, a route guidance service according to an exemplary embodiment.

The processor 200 of the navigation server 114 may include a reception unit 210, a search unit 220, a determination unit 230, a guidance unit 240, a notification unit 250, and an update unit 260. The processor 200 and the elements of the processor 200 may control the navigation server so that it performs the steps 310 to 350 of the method of providing a route guidance service shown in FIG. 3. In this case, the processor 200 and the elements of the processor 200 may be implemented to execute code of an operating system included in a memory and at least one instruction according to the code of the program. In this case, the elements of the processor 200 may be the expressions of different functions performed by the processor 200 in response to a control command provided by program code stored in the navigation server 114.

The processor 200 may load program code, stored in a file of a program for a route guidance service, into the memory. For example, when a program is executed in the navigation server 114, the processor may control the navigation server so that program code is loaded from the file of the program to the memory under the control of the operating system.

At step 310, when a source and a destination are received from the device, the reception unit 210 may receive input time information for the source and the destination. For example, a user may input the source and the destination through the device 101, which may send transmit the information to the navigation server 114 and is eventually received by the processor 200 through the reception unit 210.

At step 320, the search unit 220 may search for a section that connects the source and the destination based on the input time information. For example, during rush hour, a specific section that belongs to a plurality of sections and that connects a source and destination may be more congested than other sections. Accordingly, a section that connects the source and the destination may be searched depending on time information.

At step 330, the determination unit 230 may determine whether route information for the section is present. In this case, the route may mean a route generated by connecting a plurality of nodes present in the section that connects the source and the destination.

At step 340, if it is determined that route information for the section is present, the guidance unit 240 may provide the device with a list of at least one route present in the section. The guidance unit 240 may provide the device with an optimal route for the section and a route for the section in real time based on driving result information according to the analysis of driving information for the device. Although not illustrated, if the determination unit 230 determines that route information for the section is not present (e.g., the processor 200 is unable to generate a route within the section due to roads that do not connect within the section), then the guidance unit 240 may provide the device with an error message (e.g., a message that states “Unable to generate a route” or “No Route.”).

At step 350, the notification unit 250 may notify the ranking and game server so that it offers a reward to the device based on driving result information obtained for a set specific section as the vehicle travels on a route selected from the list. Notification for the specific section between first and second nodes included in the route is set in the ranking and game server. When the entry of the vehicle into the specific section between the first and the second nodes included in the route selected from the list is detected, the notification unit 250 may notify the device of entry information related to the entry into the specific section.

When a score assigned to the route is converted by the ranking and game server based on driving result information analyzed based on time information taken for the vehicle to travel on the route, speed information at which the vehicle travels on the route or information about each node section included in the route in the ranking and game server, the notification unit 250 may notify the ranking and game server that it provides a reward according to the score to the device. The notification unit 250 may update the route by assigning a ranking to the route based on the score that has been assigned to the route based on the driving result information that has been converted by the ranking and game server.

The notification unit 250 may update a route with constraints which have been incorporated when the ranking and game server assigns a score for the route, including the speed limit within the route, a violation matter generated as the vehicle travels on the route, or mileage information calculated as the vehicle travels on the route.

Furthermore, the update unit 260 may update the list with a new route that is generated as the vehicle travels on the new route other than routes provided by the list and that is provided by the device. The update unit 260 may update the list with a new route that is detected and generated as the vehicle drives on another route while it travels on a route selected from the list and that is provided by the device.

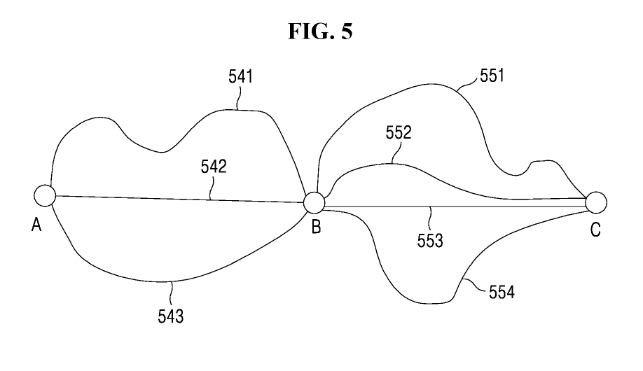

FIG. 5 is a diagram illustrating that the navigation server according to an exemplary embodiment provides the route of a section that connects a source and a destination.

A source and a destination may be input to the device. The navigation server may search for a section that connects the source and the destination received from the device. For example, nodes A, B, and C are nodes present in the section that connects the source and the destination. At least one route that connects the node A and the node B and at least one route that connects the node B and the node C may be present. More specifically, a plurality of routes 541, 542, and 543 that connect node A and node B, and a plurality of routes 551, 552, 553, and 554 that connect node B and node C, may be present. A route that connects nodes A, B, and C may be generated by selecting and combining a route connecting node A and node B and the route connecting node B and node C.

The navigation server may provide the device with an optimal route that connects nodes A, B, and C based on input time information for the source and the destination from the device. The navigation server may provide the device with a list of at least one route present in the section. When at least one route of the list provided to the device is selected, guidance of the selected route may be provided.

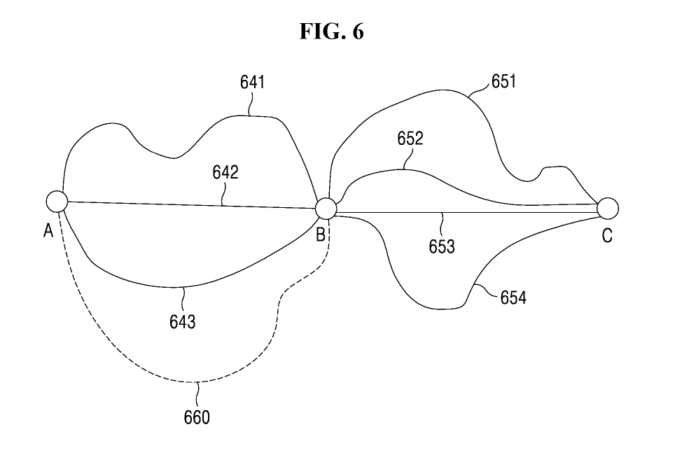

In this case, the navigation server may update the list with a new route detected and generated as the vehicle travels on another route while it travels on the route selected from the list. FIG. 6 is a diagram illustrating that a new route not provided by the navigation server is updated. For example, a plurality of routes 641, 642, and 643 that connects node A and node B, and a plurality of routes 651, 652, 653, and 654 that connects node B and node C, may be present. When the generation of a new route between node A and node B is detected, the navigation server may add the new route 660 generated between node A and node B. Accordingly, the navigation server may search for a route incorporating the new route.

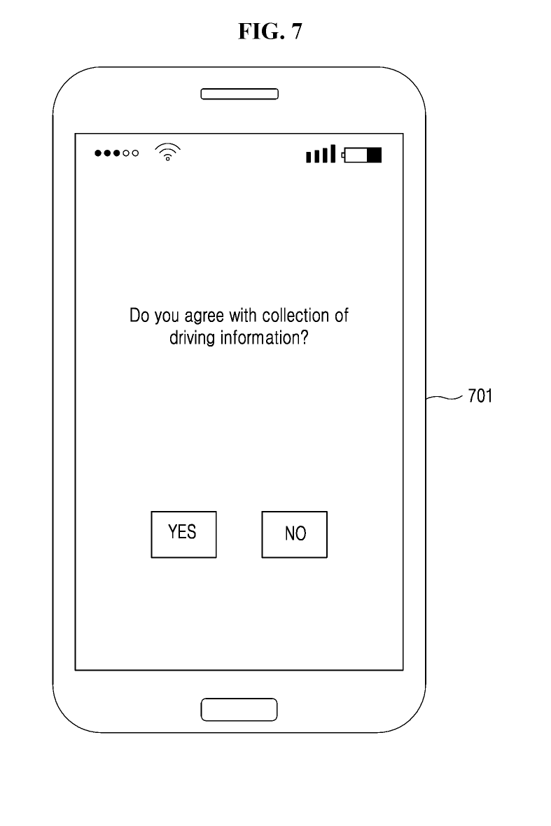

FIG. 7 is an example in which the navigation server according to an embodiment provides a user interface for querying whether driving information for a vehicle will be collected.

The navigation server may query a device 701 as to whether driving information may be collected in order to collect moving information of the device 701 disposed in a vehicle. The navigation server may provide the device 701 with a message “Do you agree with the collection of driving information?” The device 701 may output the message received from the navigation server. In this case, a user interface in which a command for the consent or rejection of the message can be input may be provided to the message provided to the device 701. The user may select “YES” or “NO” in the user interface. The navigation server may receive the consent or rejection command from the device 701.

When consent for the information collection is selected in the device 701, the navigation server may collect constraint information about constraints, such as the speed limit, mileage information, abrupt deceleration, a burst of speed, a rapid lane change of a vehicle, and driving information of the vehicle. Furthermore, user information from the device in each vehicle may be registered with the navigation server. For example, in order to check characteristics in the tendency of each user from each user, identification information, sex, and age of each user may be input. In this case, information collected from the device 701 may be collected by the collection server. More specifically, time and speed information for each section, driving information about whether acceleration or deceleration is applied, and constraint information from the device 701, such as the speed limit, abrupt deceleration, a burst of speed, and a rapid lane change, may be collected by the collection server and such information may be stored in the big data storage server.

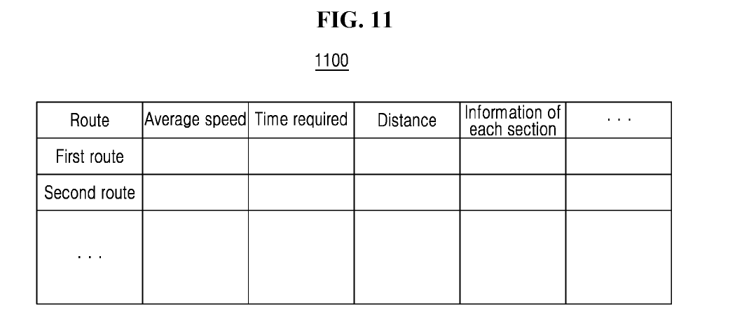

FIG. 11 is a diagram illustrating that the big data storage server according to an exemplary embodiment stores driving information. Various routes for a section that connects a source and a destination may be present. The big data storage server may store driving information 1100, collected by the collection server, in a database. The big data storage server may store information, including speed information of a vehicle according to each route, moving distance information of the vehicle, and the constraints of the vehicle. For example, the big data storage server may store an average speed of a vehicle, time taken for the vehicle, moving distance of the vehicle, and information about each section (e.g., passage time information for each section, passage speed information for each section, whether acceleration or deceleration is applied for each section, and a speed limit for each section).

The big data analysis server may analyze the characteristics of each device 701 based on driving information and constraint information stored in the big data storage server. For example, the tendency of each device may be checked by collecting direction information, speed information, and location information of a vehicle obtained from the vehicle disposed in the device. The big data analysis server may accumulate the data of traffic condition, congestion avoidance data, and new real-time route data of each section in commute time.

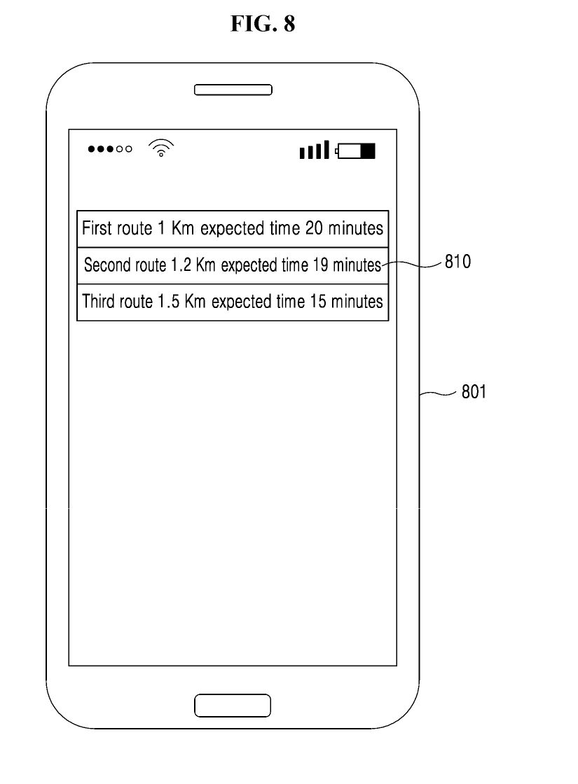

FIG. 8 is an example in which the navigation server according to an embodiment provides a list including routes for a section that connects a source and a destination.

The navigation server may provide a device 801 with a list 810 of at least one route for a section that connects a source and a destination. The navigation server may provide a first route, a second route, and a third route to the device, and may provide the distance and expected time required of each route at the same time. For example, the route included in the list 810 provided by the navigation server may have longer time required although the distance of the route that connects the source and the destination is shorter, and may have shorter time required although the distance of the route that connects the source and the destination is longer. Guidance for a route may be started once selected by a user.

Furthermore, the navigation server may change part of a route by incorporating real-time traffic condition information depending on the current location of a vehicle while it provides guidance so that the vehicle travels on the route selected by a user. The navigation server may provide the changed route to the device.

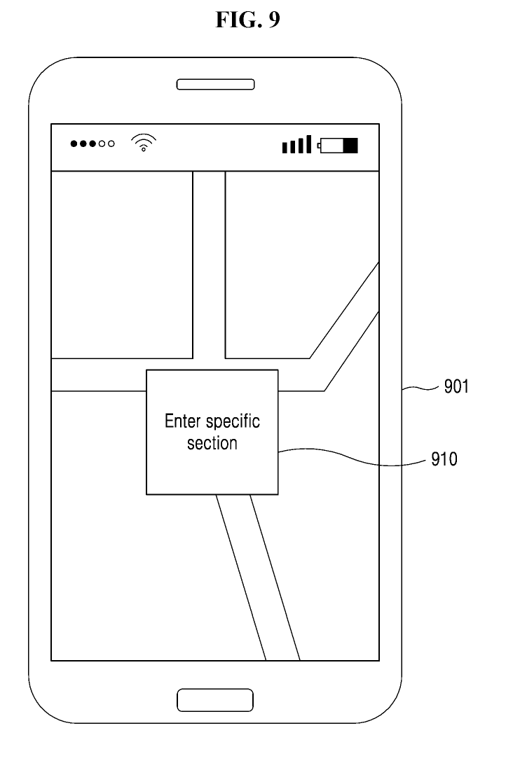

FIG. 9 is an example in which when a vehicle according to an exemplary embodiment enters a specific section set by a ranking and game server, a device is notified of the entrance.

The ranking and game server may set notification 910 for a specific section between first and second nodes included in a route. When a vehicle enters the specific section, the ranking and game server sends the notification 910 to a device 901. The ranking and game server may set a specific section for each route. In this case, the specific section may mean a game zone set in a route on which a vehicle in which the device is disposed travels. The ranking and game server may introduce a competition between vehicles and motivate the competitive spirit and the interest of a driver who drives a vehicle by setting a specific section.

Alternatively, for example, a user interface for executing a game zone and a user interface for terminating a game zone may be provided to the device of a user. The user may select the user interface for executing a game zone provided through the device. When the user selects the user interface for executing a game zone, the ranking and game server may provide notification to the device. Time information, speed information, whether acceleration or deceleration is applied, and speed limit in each section for a specific section from a point at which a user selects the user interface for executing a game zone to a point at which the user selects the user interface for terminating a game zone may be reviewed, and a corresponding log may be stored. Furthermore, optimized routes may be suggested based on information collected from the point at which the user selects the user interface for executing a game zone to the point at which the user selects the user interface for terminating a game zone. As described above, route information about a game zone section may be updated based on the collected information and distributed to users.

It is assumed that a plurality of vehicles may enter a specific section. A device may be disposed in each of the plurality of vehicles. All devices to which a navigation system service is provided may correspond with each other. Although the plurality of vehicles may have different sources and destinations, part of their routes may be the same. In other words, a specific section may have been set in a plurality of different routes.

When a vehicle enters the specific section set by the ranking and game server, the ranking and game server may push a message to the device and provide a notification that the vehicle has entered the specific section. The plurality of vehicles may pass through the specific section at different points of time. For example, the ranking and game server may assign ranking to each of the plurality of vehicles based on time information, speed information, direction information, and/or information obtained by analyzing abrupt deceleration, a burst of speed, and a rapid lane change when the vehicle passes through the specific section from each of the plurality of vehicles. Whether the vehicle has complied with constraint information (e.g., the speed limit of 80 km/h and the probation of a lane change) set in the specific section may be determined. Accordingly, the ranking and game server may reduce a score if the vehicle does not observe the constraint information, and may increase a score if the vehicle observed the constraint information. The ranking and game server may provide a function for reporting to a specific institute or other devices if the driving attributes of a vehicle falls within a predetermined parameter.

More specifically, the ranking and game server may assign a rank based on information obtained from a vehicle that has entered the specific section, and may provide a reward according to the ranking. The ranking and game server may assign a high score to a vehicle that passed through the same section within the shortest time. The ranking and game server may arrange scores assigned to the devices and assign a rank to the vehicles based on a predetermined criterion (e.g., in descending order or ascending order). For example, the ranking and game server may provide a higher score to a vehicle having higher mileage. Furthermore, the ranking and game server may assign a penalty to a vehicle or prevent the vehicle from traveling on the specific section based on the constraint information if the vehicle has violated the constraints or has many violations.

Alternatively, the ranking and game server may derive an average of routes present in each of sections, add the averages, and calculate a score by dividing the added sum by the number of routes. For example, if various routes connecting nodes A, B and C are present, the ranking and game server may derive an average (e.g., an average time required or an average speed) of routes connecting the nodes A and B, derive an average of routes connecting the nodes B and C, add the averages, and calculate a score by dividing the added sum by the number of nodes. Likewise, the ranking and game server may assign ranking based on the calculated score.

Alternatively, the ranking and game server may assign a higher score to a device disposed in a vehicle that travels on a route on which other vehicles rarely travel, or at time when other vehicles rarely travel, than to devices disposed in other devices.

Alternatively, the ranking and game server may classify all of rankings corresponding to respective vehicles (respective devices) daily or monthly, provide a score on a daily or monthly basis, and assign a ranking based on the score. The ranking and game server may also assign ranking according to commute time.

The ranking and game server according to an embodiment may inspire efficient competition between users when they travel on a route by applying a game method to activity, and may provide a corresponding reward. Furthermore, the ranking and game server may obtain a route distribution effect by applying a game method between vehicles.

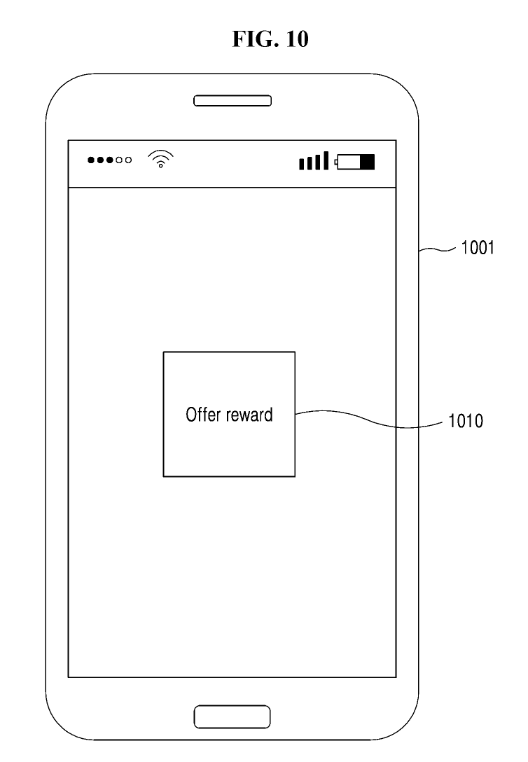

FIG. 10 is an example in which the ranking and game server according to an embodiment rewards the device.

The ranking and game server may offer a reward (1010) to the device (1001). The reward provided by the ranking and game server may not be limited. For example, the ranking and game server may offer a reward to the device based on the route, may assign a higher score to the device when a corresponding vehicle enters a specific section, and may provide the route of the shortest time and shortest distance.

For example, if a route on which a vehicle has traveled is not included in a list provided by the navigation server, the list may be updated with that route as a new route. Accordingly, the ranking and game server may offer a reward to the device of the vehicle that developed the new route. More specifically, if a list is updated with a new route generated as a vehicle travels on the new route other than a route provided by the list or a new route generated by sensing that a vehicle travels on another route while it travels on a route selected in a list through the device of the vehicle, the ranking and game server may offer a reward to the device.

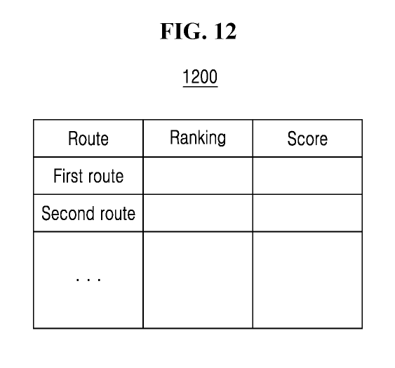

Furthermore, the ranking and game server may offer a reward to a device based on a score and ranking obtained in a specific section. FIG. 12 shows an example in which the ranking and game server assigns ranking and a score to each of piece of information, and stores ranking and score information 1200. The ranking and game server may assign ranking and a score based on information obtained with respect to a first route on which a vehicle has traveled, and may assign ranking and a score based on information obtained with respect to a second route on which a vehicle has traveled. In this case, different ranking and score may be assigned based on time information when each vehicle travels. For example, the ranking and game server may assign ranking based on scores obtained as a vehicle travels on routes for a predetermined period (e.g., for a week). For example, if a vehicle travels on a first route and a second route, the ranking and game server may assign ranking based on scores obtained as the vehicle travels on the routes.

Alternatively, the ranking and game server may assign ranking to each vehicle based on a score for a route obtained from the vehicle. Accordingly, the ranking and game server may offer a reward to a corresponding device based on the route to which the ranking has been assigned. Furthermore, the navigation server may provide a route to a device in order of rank. If the device travels on a route having a high rank, it may arrive at a destination more rapidly.

Exemplary embodiments may be implemented in the form of a combination of hardware elements, software elements, and/or hardware elements and software elements. For example, exemplary embodiments may be implemented using one or more general-purpose computers or special-purpose computers, for example, a processor (e.g., processor 200), a controller, an arithmetic logic unit (ALU), a digital signal processor, a microcomputer, a field programmable array (FPA), a programmable logic unit (PLU), a microprocessor or any other device capable of executing or responding to an instruction. A processing device may perform an operating system (OS) and one or more software applications executed on the OS. Furthermore, the processing device may access, store, manipulate, process, and generate data in response to the execution of software. For convenience of understanding, one processing device has been illustrated as being used, but a person having ordinary skill in the art may be aware that the processing device may include a plurality of processing elements and/or a plurality of types of processing elements. For example, the processing device may include a plurality of processors or a single processor and a single controller. Furthermore, other processing configurations, such as a parallel processor, are also possible.

Software may include a computer program, code, an instruction, or one or more combinations of them and may configure the processing device so that it operates as desired or may instruct the processing device independently or collectively. Software and/or data may be interpreted by the processing device or may be embodied in a machine, component, physical device, virtual equipment or computer storage medium or device of any type or a transmitted signal wave permanently or temporarily in order to provide an instruction or data to the processing device. Software may be distributed to computer systems connected over a network and may be stored or executed in a distributed manner. Software and data may be stored in one or more computer-readable recording media.

The method according to the embodiment may be implemented in the form of a program instruction executable by various computer means and stored in a computer-readable recording medium. The computer-readable recording medium may include a program instruction, a data file, and a data structure solely or in combination. The program instruction recorded on the recording medium may have been specially designed and configured for the embodiment or may be known to those skilled in computer software. The computer-readable recording medium includes a hardware device specially configured to store and execute the program instruction, for example, magnetic media such as a hard disk, a floppy disk, and a magnetic tape, optical media such as CD-ROM or a DVD, magneto-optical media such as a floptical disk, ROM, RAM, or flash memory. Examples of the program instruction may include both machine-language code, such as code written by a compiler, and high-level language code executable by a computer using an interpreter.

A distribution effect may be achieved where a plurality of vehicles may travel on various routes by providing a list of routes based on driving result information obtained by analyzing driving information for various routes present in a section that connects a source and a destination.

A reward may be offered to a device by assigning a rank to each route or converting a rank into a score based on driving information results for a commute section or an undetermined section.

A competition between vehicles can be stirred up and various routes can be pioneered by providing notification to the device of a vehicle that enters a specific section set in a section that connects a source and a destination and applying a game method to the specific section.

A greater reward may be offered to the device of a vehicle that travels on a route not preferred by other vehicles when compared to the devices associated with the other vehicles.

Although the present invention has been described in connection with the limited embodiments and the drawings, the present invention is not limited to the embodiments. A person having ordinary skill in the art to which the present invention pertains can substitute, modify, and change the present invention without departing from the technological spirit of the present invention from the description.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A method of providing route guidance by a navigation server, comprising steps of:
receiving input time information for a source and a destination from a device when the source and the destination are inputted on the device;
searching for a section connecting the source and the destination based on the input time information;
determining whether a route for the section is present, wherein the route is generated by connecting a plurality of nodes within the section;
providing the device with a list of at least one route within the section if the route for the section is present; and
notifying a ranking and game server so that the ranking and game server offers a reward to the device based on driving result information obtained with respect to a specific section set as a vehicle travels on a route selected from the list.

2. The method of claim 1, wherein the step of notifying the ranking and game server so that the ranking and game server offers a reward to the device based on the driving result information obtained with respect to a specific section set as the vehicle travels on the route selected from the list comprises:
a step of notifying the device of entry information related to the entry into the specific section if notification for the specific section between first and second nodes included in the route is set in the ranking and game server and when the entry into the specific section between the first and the second nodes included in the route selected from the list is detected.

3. The method of claim 1, further comprising steps of:
updating the list with a new route generated when the device detects that the vehicle travels on the new route other than the at least one route included in the list; and
updating the list with a new route generated when the device detects that the vehicle travels on another route when a route has been selected from the list.

4. The method of claim 1, wherein the step of providing the device with the list of at least one route within the section if the route for the section is present further comprises:
a step of providing the device with an optimal route for the section, in real time, based on driving result information according to analysis of driving information of the device.

5. The method of claim 1, wherein the step of notifying the ranking and game server so that the ranking and game server offers a reward to the device based on the driving result information obtained with respect to the specific section set as the vehicle travels on the route selected from the list comprises:
a step of offering a reward, according to a score, to the device when the ranking and game server converts driving result information analyzed based on time information taken for the vehicle to travel on the route, speed information at which the vehicle travels on the route, or information about each node section included in the route, into the score assigned to the route.

6. The method of claim 5, wherein the step of notifying the ranking and game server so that the ranking and game server offers a reward to the device based on the driving result information obtained with respect to the specific section set as the vehicle travels on the route selected from the list further comprises:
a step of updating the route when the ranking and game server assigns a rank for the route based on the converted score assigned to the route, based on the driving result information.

7. The method of claim 5, wherein the step of notifying the ranking and game server so that the ranking and game server offers a reward to the device based on the driving result information obtained with respect to the specific section set as the vehicle travels on the route selected from the list further comprises:
a step of updating the route in which constraints have been incorporated when the ranking and game server assigns the score for the route based on the constraints comprising: speed limit in the route, a violation matter in traveling on the route, or mileage information calculated in traveling on the route.

8. A navigation server for providing route guidance, comprising:
a processor configured to:
receive input time information for a source and a destination from a device when the source and the destination are input on the device;
search for a section connecting the source and the destination based on the input time information;
determine whether a route for the section is present, wherein the route is generated by connecting a plurality of nodes within the section;
provide the device with a list of at least one route within the section if the route for the section is present; and
notify a ranking and game server so that the ranking and game server offers a reward to the device based on driving result information obtained with respect to a specific section set as a vehicle travels on a route selected from the list.

9. The navigation server of claim 8, wherein the processor is further configured to notify the device of entry information related to the entry into the specific section if notification for the specific section between first and second nodes included in the route is set in the ranking and game server and when the entry into the specific section between the first and the second nodes included in the route selected from the list is detected.

10. The navigation server of claim 8, wherein the processor is further configured to update the list with a new route generated when the device detects that the vehicle travels on the new route other than the at least one route included in the list or to update the list with a new route generated when the device detects that the vehicle travels on another route when a route has been selected from the list.

11. The navigation server of claim 8, wherein the processor is further configured to provide the device with an optimal route for the section, in real time, based on driving result information according to analysis of driving information of the device.

12. The navigation server of claim 8, wherein the processor is further configured to offer a reward, according to a score, to the device when the ranking and game server converts driving result information analyzed based on time information taken for the vehicle to travel on the route, speed information at which the vehicle travels on the route, or information about each node section included in the route into the score assigned to the route.

13. The navigation server of claim 12, wherein the processor is further configured to update the route when the ranking and game server assigns a rank for the route based on the converted score assigned to the route, based on the driving result information.

14. The navigation server of claim 12, wherein the processor is further configured to update the route in which constraints have been incorporated when the ranking and game server assigns the score for the route based on the constraints comprising: speed limit in the route, a violation matter in traveling on the route, or mileage information calculated in traveling on the route.

15. An information provision system, comprising:
a collection server configured to collect driving information generated when a vehicle travels on a route for a section connecting a source and a destination based on the source, the destination, and input time information for the source and the destination;
a big data storage server configured to store the driving information collected by the collection server;
a big data analysis server configured to obtain driving result information by analyzing the driving information stored in the big data storage server;
a ranking and game server configured to assign ranking to a route on which the vehicle has traveled based on the driving result information, offer a reward according to the ranking, and set notification for a specific section between first and second nodes included in the route; and
a navigation server configured to provide a list of at least one route within the section connecting the source and the destination in real time and to update an optimal route for the vehicle based on the driving result information.

16. The information provision system of claim 15, wherein the big data analysis server is further configured to analyze driving result information comprising at least one of: time information taken for the vehicle to travel on the route, speed information at which the vehicle travels on the route, and information about each section included in the route.

17. The information provision system of claim 15, wherein the big data analysis server is further configured to analyze a new route generated when the vehicle travels on a different route other than a route provided by the navigation server or a new route generated when the vehicle travels a different route when a route has been selected from the list.

18. The information provision system of claim 15, wherein the navigation server is further configured to update the list with a route on which the vehicle has traveled as a new route if the route on which the vehicle has traveled is not included in the list provided by the navigation server.

19. The information provision system of claim 15, wherein the ranking and game server is further configured to convert the driving result information analyzed by the big data analysis server into a score assigned to a route on which the vehicle has traveled, and assign a rank for the route on which the vehicle has traveled based on the converted score.

20. The information provision system of claim 19, wherein the ranking and game server is further configured to offer a greater reward to a device connected to the vehicle that has traveled on a route not preferred by other vehicles when compared to the devices associated with the other vehicles.
